(19) United States
(12) Patent Application Publication
(10) Pub. No.: US 2025/0310278 A1
(43) Pub. Date: Oct. 2, 2025

(54) PACKET BUFFER LATENCY MITIGATION IN A NETWORK DEVICE

(71) Applicant: Marvell Asia Pte Ltd, Singapore (SG)

(72) Inventor: Jacob Jul SCHRODER, Lyngby (DK)

(21) Appl. No.: 19/094,285

(22) Filed: Mar. 28, 2025

Related U.S. Application Data
(60) Provisional application No. 63/571,232, filed on Mar. 28, 2024.

(51) Int. Cl. H04L 49/90; H04L 47/127

(52) U.S. Cl. CPC H04L 49/9026; H04L 47/127

(57) ABSTRACT

A network device includes a plurality of network interfaces and an ingress processor configured to process packets received by the network device to determine network interfaces, among the plurality of network interfaces, via which the packets are to be transmitted by the network device. The network device also includes a memory device configured to buffer packet data corresponding to the packets while the packets are being processed by the network device and a memory controller configured to select a buffering scheme for buffering a packet in the memory device based on a congestion state of a network interface via which the packet is to be transmitted. The buffering scheme is selected among a first buffering scheme having a first latency associated with buffering packet data and a second buffering scheme having a second latency, smaller than the first latency, associated with buffering packet data.

### CROSS REFERENCES TO RELATED APPLICATIONS

This application claims the benefit of U.S. Provisional Patent Application No. 63/571,232, entitled “Latency Mitigation in a Shared Packet Buffer,” filed on Mar. 28, 2024, the disclosure of which is hereby expressly incorporated herein by reference in its entirety.

### Field of Technology

The present disclosure relates generally to network devices, and more particularly, to packet buffer latency mitigation in a network device.

### BACKGROUND

Network devices, such as switches or routers, forward packets through a network based on addresses in the packets. A network device typically includes a plurality of network interfaces coupled to different network links. The network device receives a packet via one network interface and processes address information in a header of the packet to decide via which other network interface or network interfaces the packet is to be transmitted from the network device. The network device then forwards the packet to the determined one or more other network interfaces. In various network devices, entire packets, or payloads of the packets, are temporarily stored in a packet memory during processing, and are subsequently read from the packet memory for transmission of the packet via the other network interface or network interfaces of the network device. In architectures in which entire packets, or payloads of the packets, are stored in a packet memory during processing of the packets by the network device, the temporary storage of packets in the packet memory sometimes introduces latency to transmission of the packets from the network device.

### SUMMARY

In an embodiment, a network device comprises a plurality of network interfaces and an ingress processor configured to process packets received by the network device to determine network interfaces, among the plurality of network interfaces, via which the packets are to be transmitted by the network device. The network device also comprises a memory device configured to buffer packet data corresponding to the packets while the packets are being processed by the network device. The network device further comprises a memory controller configured to select a buffering scheme for buffering a packet in the memory device based on a congestion state of a network interface via which the packet is to be transmitted by the network device, the buffering scheme being selected among a first buffering scheme having a first latency associated with buffering packet data in the memory device and a second buffering scheme having a second latency, smaller than the first latency, associated with buffering packet data in the memory device.

In another embodiment, a method for processing packets in a network device includes receiving, by an ingress processor of the network device, a packet received by the network device. The method also includes processing, by the ingress processor of the network device, the packet at least to determine a network interface, among a plurality of network interfaces of the network device, via which the packet is to be transmitted from the network device. The method further includes selecting a buffering scheme for buffering the packet in a memory device while the packet is being processed by the network device, the buffering scheme being selected, based on a congestion state of the network interface via which the packet is to be transmitted from the network device, among a first buffering scheme having a first latency associated with buffering packet data in the memory device and a second buffering scheme having a second latency, smaller than the first latency, associated with buffering packet data in the memory device. The method additionally includes buffering the packet according to the selected buffering scheme in the memory device.

### BRIEF DESCRIPTION OF THE DRAWINGS

FIG. 1 is a block diagram of an example network device configured to handle buffering of packet data based on congestion states of network interfaces via which the corresponding packets are to be transmitted from the network device, according to an embodiment.

FIG. 2 is a diagram of an example early forward queue used with the network device of FIG. 1, according to an embodiment.

FIG. 3 is a block diagram of an example memory device used with the network device of FIG. 1, according to an embodiment.

FIG. 4A is a diagram of an example write request provided from an ingress processor to a memory device in the network device of FIG. 1, according to an embodiment.

FIG. 4B is a diagram of an example data unit used to transmit packet data from a memory device to an egress processor in the network device of FIG. 1, according to an embodiment.

FIG. 5 is a block diagram of an example interface between a memory device and one or more egress processors used with the network device of FIG. 1, according to an embodiment.

FIG. 6 is a diagram of an example egress processor used with the network device of FIG. 1, according to an embodiment.

FIG. 7 is a flow diagram of an example method for processing packets in a network device, according to an embodiment.

### DETAILED DESCRIPTION

As discussed above, some network devices are configured to store packet data (e.g., packet payloads) in a packet memory of a memory device while the corresponding packets are being processed by the network device, and to subsequently retrieve the packet data from the packet memory for transmission of the packets from the network device. In a typical network device, an egress processor of the network device obtains packet data from a packet memory by issuing a read request to a memory device. The memory device receives a read request requesting packet data, determines, based on the read request, a location at which the packet data is stored in the packet memory, retrieves the packet data from the determined location in the packet memory, and transmits the packet data to the egress processor for transmission of the corresponding packet via a network interface of the network device. In some situations, the time that it takes to issue a read request to the packet memory and to receive the packet data from the packet memory adds unnecessary latency to transmission of the packet from the network device, particularly during times when the network interface via which the packet is to be transmitted is not congested as is available for transmission of the packet.

In embodiments described below, a network device is configured to handle buffering of packet data in a memory device based on congestion states of network interfaces via which the corresponding packets are to be transmitted from the network device. In an embodiment, a memory controller of the memory device is configured to store packet data, corresponding to a packet that is to be transmitted via a network interface that is in a congested state, in a buffer of the memory device and to subsequently provide the packet data to an egress processor in response to receiving a read request for the packet data from the egress processor. Because the network interface via which the packet is to be transmitted is in a congested state, the time associated with requesting and receiving the packet data from the memory device does not add latency to transmission of the packet from the network device, in an embodiment. On the other hand, the memory controller is configured to place packet data, corresponding to a packet that is to be transmitted via a network interface that is not in a congested state, in an early forward queue in the memory device. The memory device is configured to forward the packet data to the egress processor coupled to the network interface from the early forward queue without waiting for a read request for the packet data to be received from the egress processor, in an embodiment. The egress processor is configured to store the packet data in a local cache memory and to read the packet data from the local cache memory when the egress processor is ready to transmit the corresponding packet via the network interface of the network device. Thus, the packet data is available at the egress processor when the packet processor is ready to transmit the packet and the latency associated with the egress processor requesting the packet data and waiting for the packet data to be received from the memory device is reduced or eliminated, in at least some embodiments.

In some embodiments, the memory controller is configured to place the packet data, corresponding to a packet that is to be transmitted via a network interface that is not in a congested state, in the early forward queue in addition to storing the packet data in the buffer of the memory device. In an embodiment, the memory device is configured to transmit packet data to an egress processor from the buffer with a higher priority relative to transmission of packet data to the egress processor from the early forward queue. Transmission of the packet data from the buffer is also handled with higher priority relative to transmission of packet data from the early forward queue in an interface between the memory device and the egress processor, in an embodiment. The packet data from the early forward queue is thus transmitted using bandwidth that is not used for transmission of packet data from the buffer, in an embodiment. As explained in more detail below, storing the packet data in both the buffer and the early forward queue ensures that the packet data will be transmitted to the egress processor even if the packet data from the early forward queue does not reach egress processor, for example due to being dropped due to internal congestion, in an embodiment. These and other techniques described herein allow the network device to reduce or eliminate latency associated with the egress processor issuing a read request to request the packet data from the memory device for uncongested network interfaces without interfering with the regular transmission of packet data from the buffer and without requiring excessively large local cache memory for storing packet data directed to congested network interfaces coupled to the egress processor, in various embodiments.

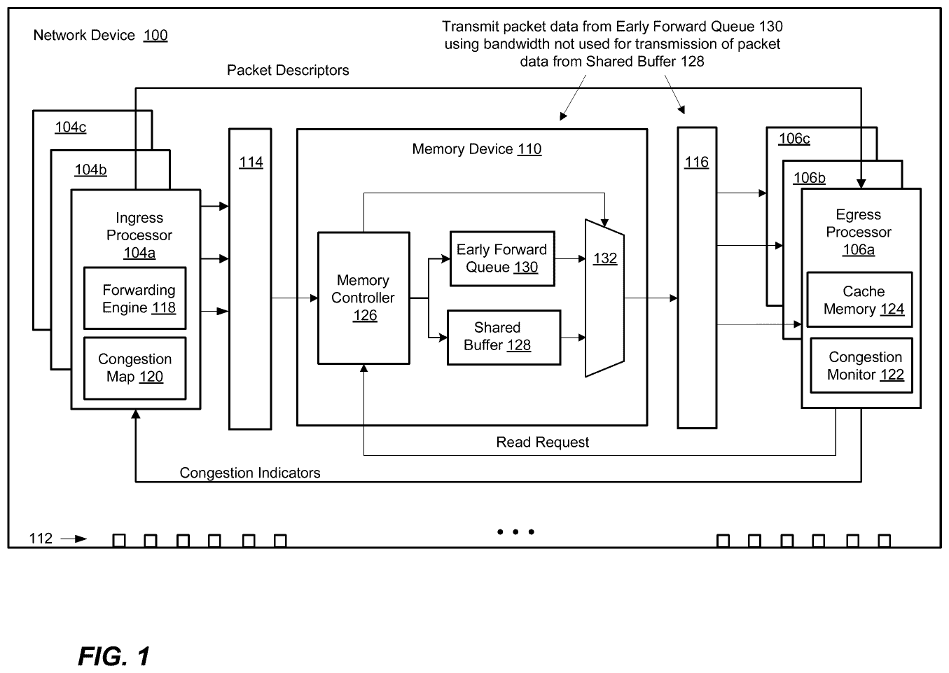

FIG. 1 is a block diagram of an example network device 100 configured to handle buffering of packet data (e.g., payloads of packets) based on congestion states of network interfaces via which the corresponding packets are to be transmitted from the network device, according to an embodiment. The network device 100 includes a plurality of network interfaces (e.g., ports) 112 configured to couple to respective network links. The network device 100 also includes a plurality of processors, including one or more ingress processors 104 and one or more egress processors 106, coupled to the network interfaces 112. The processors 104, 106 are configured to receive packets via ones of the network interfaces 112, to determine via which of the network interfaces 112 the packets are to be transmitted, and to transmit the packets via the determined network interfaces 112 towards the destinations of the packets, in an embodiment. Although three ingress processors 104 and three egress processors 106 are illustrated in FIG. 1, the network device 100 includes another suitable number (e.g., 1, 2, 4, 5, 6, etc.) of ingress processors 104 and/or another suitable number (e.g., 1, 2, 4, 5, 6, etc.) of egress processors 106, in other embodiments. Further, although the processors 104 are illustrated in FIG. 1 as being ingress processors and the processors 106 are illustrated in FIG. 1 as being egress processors, each of the processors 104, 106 includes functionality of both an ingress processor configured to receive packets via network interfaces 112 and an egress processor configured to transmit packets via the network interfaces 112, in an embodiment. In an embodiment, each of the processors 104, 106 is coupled to a respective subset of network interfaces 112 and is configured to receive and transmit packets via the subset of network interfaces 112.

The network device 100 also includes a memory device 110. The memory device 110 is coupled to the ingress processors 104 via an interface 114 between the memory device 110 and the ingress processors 104, in an embodiment. The memory device 110 is also coupled to the egress processors 106 via an interface 116 between the memory device 110 and the egress processors 106, in an embodiment. The memory device 110 is generally configured to temporarily store at least portions of packets (also referred to herein as “packet data”) while the packets are processed by the network device 100 and before the packets are transmitted from the network device 100. For example, packet data is stored in the memory device 110 to sustain congestion of network interfaces 112, until the network interfaces 112 become available for transmission of the packets, in an embodiment. The network device is thus configured to include sufficient buffering capacity to sustain congestion of network interfaces 112, in an embodiment. The memory device 110 is configured to receive the packet data from an ingress processor 104 and to subsequently transmit the packet data to an egress processor 106 for transmission of the corresponding packet via a network interface 112 coupled to the egress processor 106, in an embodiment.

The memory device 110 includes a memory controller 126, a shared buffer 128, an early forward queue 130, and a multiplexer 132, in an embodiment. In an embodiment, the shared buffer 128, the early forward queue 130, and the multiplexer 132 correspond to a memory cluster in the memory device 110. Although the memory device 110 is illustrated in FIG. 1 as including a single memory cluster that includes a single shared buffer 128, a single early forward queue 130, and a single multiplexer 132, the memory device 110 includes multiple memory clusters, each memory cluster including a respective shared buffer 128, a respective early forward queue 230, and a respective multiplexer 232, in some embodiments. The memory controller 126 is generally configured to control operation of one or more memory clusters in the memory device 110. In an embodiment in which the memory device 110 includes multiple memory clusters, the memory controller 126 is configured to control operation of the multiple memory clusters. In another embodiment in which the memory device 110 includes multiple memory clusters, the memory device 110 includes respective memory controllers 126 configured to control operation of respective ones of the multiple memory clusters.

In an embodiment, the memory device 110 is shared among multiple (e.g., all) of the ingress processors 104 and egress processors 106 and is configured to store packet data of packets that is to be transmitted via network interfaces 112 coupled to the multiple (e.g., all) egress processors 106. Because the memory device 110 is shared, the memory device 110 is more efficient in terms of total size, power consumption, etc., as compared to systems in which respective memory devices are provided for respective ones of the egress processors, in at least some embodiments. In an embodiment in which the memory device 110 is shared by multiple (e.g., all) egress processors 106, the memory device 110 is physically located farther away from the egress processors 106 as compared to systems in which respective memory devices are provided for respective ones of the egress processors. For example, in an embodiment in which the memory device 110 is shared by multiple (e.g., all) egress processors 106, the memory device 110 is placed centrally on a die that includes the ingress processors 104 and the egress processors 106, or at another physical location that is relatively farther from the egress processors 106 as compared to systems in which respective memory devices are provided for respective ones of the egress processors. Because the memory device 110 is physically located relatively far away from the egress processors 106, latency associated with retrieval of packet data from the memory device 110 is increased as compared to systems in which respective memories are provided for respective ones of the egress processors. In an embodiment, the latency, or the time between when a read request for packet data is provided by an egress processor 106 to the memory device 110 and when the packet data is received by the egress processor 106 from the memory device 110, results in a delay of transmission of the corresponding packet from the network device 100, particularly in situations in which the network interface 112 via which the packet is transmitted is not congested and is ready to transmit the packet before the packet data is received from the memory device 110.

In an embodiment, the memory controller 126 of the memory device 110 is configured to handle buffering of packets based on congestion states of the network interfaces 112 via which the packets are to be transmitted by the network device 100. For example, the memory controller 126 is configured to, for a packet that is directed to a congested network interface 112 coupled to an egress processor 106, cause packet data to be transmitted to the egress processor 106 in response to receiving a read request for the packet data from the egress processor 106, in an embodiment. On the other hand, for a packet that is directed to an uncongested network interface 112 coupled to an egress processor 106, the memory controller 126 is configured cause packet data to be transmitted to the egress processor 106 without waiting to receive a read request for the packet data from the egress processor 106, in an embodiment. Transmission of packet data from the memory device 110 to an egress processor 106 without waiting to receive a read request for the packet data from the egress processor 106 is sometimes referred to herein as “early forward” or “early forward operation”. Because the memory controller 126 is configured to early-forward packet data of a packet directed to an uncongested network interface 112 to an egress processor 106 without waiting to receive a read request for the packet data from the egress processor 106, the packet data is available at the egress processor 106 when the egress processor 106 is ready to transmit the packet, in an embodiment. Thus, latency associated with retrieval of packet data by the egress processors 106 from the memory device 110 is reduced or eliminated in situation in which network interfaces 112 via which the corresponding packets are to be transmitted are not congested, in at least some embodiments.

In an embodiment, each of the one or more ingress processors 104 includes, or is coupled, to a forwarding engine 118 and a congestion map 120. The forwarding engine 118 is configured to analyze header information in packets, or in packet descriptors corresponding to the packets, to determine network interfaces 112 via which to the packets are to be transmitted from the network device 100. For example, in some embodiments, the forwarding engine 118 is configured to use a portion of a header of a packet, such as a destination address, to look up in a forwarding database (not shown in FIG. 1) an indication of a network interface or network interfaces via which the packet is to be transmitted from the network device 100. The congestion map 120 is configured to maintain congestion states of the network interfaces 112, in an embodiment. As explained in more detail below, the congestion states of the network interfaces 112 are used by the ingress processors 104 to determine whether to mark packets for early forward to egress processors 106, in an embodiment.

Each of the one or more egress processors 106 includes, or is coupled to, a congestion monitor 122 and a cache memory 124, in an embodiment. The congestion monitor 122 is configured to monitor congestion of the network interfaces 112 coupled to the egress processor 106, in an embodiment. The egress processors 106 are configured to provide the congestion states determined by the congestion monitor 122 to the ingress processors 104, in an embodiment. The ingress processors 104 are configured to update congestion states in the congestion map 120 based on the indications of the congestion states received from the egress processors 106, in an embodiment.

In an embodiment, the congestion monitor 122 of an egress processor 106 is configured to monitor amount of data in egress queues that store packets for transmission via respective network interfaces 112 coupled to the egress processor 106. The congestion monitor 122 is configured to determine that a network interface 112 is congested when the amount of data stored in the egress queue corresponding to the network interface 112 exceeds a predetermined threshold, or when amount of free space in the egress queue corresponding to the network interface 112 is below a predetermined threshold, in an embodiment. In other embodiments, the congestion monitor 122 is configured to determine congestion states of the network interface 112 in other suitable manners. The one or more egress processors 106 are configured to periodically (e.g., every one or few clock cycles) provide congestion indications indicating the current congestion states of the network interfaces 112 to the one or more ingress processors 104. The one or more ingress processors 104 are configured to update the congestion map 120 based on the congestion indicators received from the one or more egress processors 106 to maintain current congestion states of the network interfaces 112 coupled to the egress processors 106, in an embodiment. In an embodiment in which the network device 100 includes multiple egress processors 106 and multiple ingress processors 104, each of the egress processors 106 is configured to provide congestion indicators of the network interfaces 112 coupled to the egress processor 106 to each of the ingress processors 104. Thus, the congestion map 120 of each of the ingress processors 104 is configured to maintain current congestion states of all network interfaces 112, in an embodiment.

As discussed above, the memory controller 126 of the memory device 110 is configured to buffer packet data based on a congestion state of the network interface 112 via which the corresponding packet is to be transmitted from the network device 100, in an embodiment. For example, the memory controller 126 is configured to select a buffering scheme for buffering packet data corresponding to a packet based on a congestion state of a network interface 112 via which the packet is to be transmitted by the network device 100. In an embodiment, the memory controller 126 is configured to select the buffering scheme among a first buffering scheme having a first latency associated with buffering packet data in the memory device 110 and a second buffering scheme having a second latency, smaller than the first latency, associated with buffering packet data in the memory device 110. In an embodiment, the memory controller 126 is configured to i) select the first buffering scheme based on determining that the network interface 112 via which the corresponding packet is to be transmitted from the network device 100 is congested and ii) select the second buffering scheme based on determining that the network interface 112 via which the corresponding packet is to be transmitted from the network device 100 is not congested, in an embodiment. In an embodiment, the first buffering scheme includes storing the packet data in the shared buffer 128 and transmitting the packet data from the shared buffer 128 to an egress processor 106 in response to receiving a read request for the packet data from the egress processor 106. The second buffering scheme includes storing the packet data in the early forward queue 130 and forwarding the packet data to the egress processor 106, coupled to the network interface 112 via which the packet is to be transmitted, without waiting to receive a read request for the packet data from the egress processor 106. In an embodiment, the second buffering scheme includes storing the packet data in the early forward queue 130 in addition to storing the packet data in the shared buffer 128. Thus, the second buffering scheme includes storing the packet data in both the shared buffer 128 and the early forward queue 130, in an embodiment. As explained in more detail below, storing the packet data in both the shared buffer 128 and the early forward queue 130 ensures that the packet data will be transmitted to the egress processor 106 even if the packet data from the early forward queue 130 does not reach egress processor 106, for example due to being dropped in the interface 116 that couples the memory device 110 to the egress processor 106, in an embodiment.

As explained in more detail below, the egress processors 106 are configured to receive packet data from the memory device 110 and place the packet data in the cache memory 124 for subsequent retrieval and transmission via the network interfaces 112 coupled to the egress processors 106. In various embodiments, because the memory device 110 is configured to forward, to an egress processor 106, packet data directed to an uncongested network interface 112 coupled to the egress processor 106, without waiting for a read request for the packet data to be received from the egress processor 106, the packet data is available in the cache memory 124 of the egress processor 106 when the egress processor 106 is ready to transmit the packet, or soon after the egress processor 106 is ready to transmit the packet, in at least some scenarios, in an embodiment. Thus, latency associated with issuing a read request by the egress processor 106 to request the packet data from the memory device 110, and receiving the packet data by the egress processor 106 in response to the read request, is reduced or eliminated, in at least some scenarios, in an embodiment. Further, because the memory device 110 is configured to buffer packet data directed to a congested network interface 112 in the shared buffer 128, and transmit the packet data to the egress processor 106 coupled to the network interface 112 in response to receiving a read request from the egress processor 106, the packet data directed to congested network interfaces 112 is buffered longer in the shared buffer 128 relative to packet data that is directed to uncongested network interfaces 112, in at least some embodiments. Thus, on the one hand, buffering capacity of the shared buffer 128 is used to sustain congestion of the network interfaces 112, and, on the other hand, packet data directed to uncongested network interfaces 112 is quickly provided to the egress processors 106 so as to not add latency to transmission of the corresponding packets via the uncongested network interfaces 112, in at least some situations, in an embodiment. Accordingly, the latency associated with issuing read requests by the egress processors 106 and receiving the packet data by the egress processors 106 in response to the read requests, is reduced or eliminated, in at least some scenarios, without requiring excessively large cache memory 124 for storing packet data directed to congested network interfaces 112 coupled to the egress processor 106, in various embodiments.

In an embodiment, when an ingress processor 104 receives a packet and determines a network interface 112 via which the packet is to be transmitted from the network device 100, the ingress processor 104 issues a write request to the memory controller 126 to request packet data to be stored in the memory controller 126. In an embodiment, the ingress processor 104 is configured to determine, based on the congestion map 120, whether the network interface 112 via which the packet is to be transmitted is currently congested. The ingress processor 104 is configured to include, in the write request, a congestion indication indicating whether the network interface 112 via which the packet is to be transmitted is currently congested, in an embodiment. The ingress processor is further configured to, when the packet is to be transmitted via a network interface 112 that is not congested, indicate, to the memory controller 126, to which egress processor 106 the packet data is to be forwarded without waiting for a read request to be received, in an embodiment. For example, the ingress processor is configured to include an indication of the egress processor 106 to which the packet data is to be forwarded in the write request issues to the memory controller 126, in an embodiment. In an embodiment, the write request includes an early forward indicator field, and the ingress processor 104 is configured to, when the network interface 112 via which the packet is to be transmitted is not congested, set the early forward indicator field to an identifier of the egress processor 106 to which the packet data is to be forwarded. On the other hand, when the network interface 112 via which the packet is to be transmitted is congested, the ingress processor 104 is configured to set the early forward indicator field in the write request to a value other than a valid identifier of an egress processor 106, in an embodiment. The value of the early forward field in the write request thus serves as an indicator of whether the network interface 112 via which the packet is to be transmitted is congested, in addition to indicating the egress processor 106 to which the packet data is to be forwarded without waiting for a read request in the case that the network interface 112 is not congested, in an embodiment. In other embodiments, the ingress processor 104 is configured to indicate, to the memory controller 126, whether the network interface via which the packet is to be transmitted and/or to which egress processor 106 the packet data is to be forwarded, in other suitable manners.

The memory controller 126 is configured to receive the write request for storing packet data from the ingress processor 104 and to allocate memory space in the shared buffer 128 for storing the packet data, in an embodiment. The memory controller 126 is configured to store the packet data at the memory location in the shared buffer 128, in an embodiment. The memory controller 126 is also configured to provide an indication of the allocated memory location, at which the packet data is stored in the shared buffer 128, to the ingress processor 104, in an embodiment. The ingress processor 104 is configured to include the indication of the memory location, at which the packet data is stored in the shared buffer 128, in a packet descriptor corresponding the packet. In another embodiment, the ingress processor 104 is configured to allocate memory space in the shared buffer 128 for storing the packet data. In this embodiment, the ingress processor is configured to include, in a write request that the ingress processor 104 provide to the memory controller 126, an indication of a memory location for storing packet data in the shared buffer 128 of the memory device 110. In other embodiments, allocation of memory space for storing packet data in the shared buffer 128 is performed in other suitable manners.

The ingress processor 104 is configured to provide the packet descriptor to the egress processor 106 coupled to the network interface 112 via which the packet is to be transmitted from the network device 100. As explained in more detail below, the egress processor 106 is configured to use the indication of the memory location in the packet descriptor to identify the packet data that corresponds to the packet, in an embodiment.

In some embodiments, the packet data is split into a plurality of packet chunks (also sometimes referred herein as “cells”) for storage of the packet data in the shared buffer 128 of the memory device 110. For example, the ingress processor 104 is configured to split packet data of at least some packets (e.g., relatively larger packets) into a plurality of packet cells for storage in the shared buffer 128. In an embedment, when the ingress processor 104 splits packet data into a plurality of packet cells, the ingress processor 104 issues respective write requests to the memory controller 126 requesting to store respective ones of the plurality of packet cells in the memory controller 126. In another embodiment, the memory controller 126 is configured to split the packet data into a plurality of packet cells for storage in the shared buffer 128. The memory controller 126 is configured to allocate one or more respective memory locations in the shared buffer 128 for storage of one or more packet cells of a packet and to provide indications of the one or more memory locations (also sometimes referred to herein as “cell pointers”) to the ingress processor 104, in some embodiments.

The memory controller 126 is also configured to determine, based on the congestion indication in the write request, whether the network interface 112 via which the packet is to be transmitted is congested, in an embodiment. The memory controller 126 is configured to, in response to determining that the packet is to be transmitted via a network interface 112 that is currently not congested, store the packet data in the early forward queue 130 in addition to storing the packet data in the shared buffer 128. The memory device 110 is configured to forward the packet data from the early forward queue 130, to the egress processor 106 to which the packet data is directed, without waiting to receive a read request from the egress processor 106, in an embodiment. As explained in more detail below, storing the packet data in the early forward queue 130 in addition to storing the one or more packet cells in the shared buffer 128 ensures that the packet data will be transmitted to the egress processor 106 even if the packet data from the early forward queue does not reach the egress processor 106, for example due to being dropped in case of congestion in the interface 116 between the memory device 110 and the egress processor 106.

The early forward queue 130 is a first in first out (FIFO) queue, in an embodiment. In another embodiment, the early forward queue 130 is a suitable queue different than a FIFO queue. Although a single early forward queue 130 is illustrated in FIG. 1, the memory device 110 includes multiple early forward queue 130, in some embodiments. For example, respective early forward queues 130 are used by the memory device 110 to store packet data directed to respective egress processors 106, respective subsets of egress processors 106, respective network interfaces 112, etc., in some embodiments. As another example, a respective early forward queue 130 is provided for each memory bank in the shared buffer 128 of the memory device 110, in an embodiment. For case of explanation, operations related to early-forward are generally described herein with reference to a single early forward queue 130. It is noted, however, that same or similar operations are used with multiple early forward queues 130, in some embodiments.

In an embodiment, the memory device 110 is configured to handle transmissions of packet data from the shared buffer 128 with a higher priority relative to transmissions of packet data from the early forward queue 130. For example, in an embodiment, the memory controller 126 of the memory device 110 is configured to control the multiplexer 132 to transmit packet data from the early forward queue 130 via the interface 116 to egress processors 106 when no packet data is being transmitted from the shared buffer 128 to the egress processors 106. The interface 116 is also configured to handle transmissions of packet data from the shared buffer 128 with a higher priority relative to transmissions of packer data from the early forward queue 130, in an embodiment. For example, in an embodiment, the interface 116 is configured to transmit packet data transmitted from the early forward queue 130 when no packet data transmitted from the shared buffer 128 is being transmitted by the interface 116. The interface 116 is also configured to drop packet data transmitted from the early forward queue 130 to avoid queue overflow in the interface 116, in an embodiment. On the other hand, the interface 116 is configured to implement a backpressure technique with the memory device 110 to temporarily suspend transmission of packet data from the shared buffer 128 at times of congestion in the interface 116, in order to avoid queue overflow in the interface 116 without the packet data being dropped in the interface 116, in an embodiment. The memory device 110 and the interface 116 are thus configured to transmit packet data from the early forward queue 130 using bandwidth that is unused by transmissions of packet data from the shared buffer 128, in an embodiment. As a result, packet data from the shared buffer 128 is provided in a controlled and guaranteed manner to the egress processors 106 in response to receiving read requests from the egress processors 106, whereas the packet data from the early forward queue 130 is transmitted to the egress processors 106 in a best effort manner, in an embodiment. As described in more detail below, if certain packet data that is transmitted to an egress processor 106 from the early forward queue 130 is not received by the egress processor 106, or receipt of the packet data is delayed, the egress processor 106 is configured to request the packet data by issuing a read request to the memory device 110 and receiving the packet data transmitted from the shared buffer 128 in response to the read request, in an embodiment. Thus, packet data is not lost even if the packet data is dropped in the process of transmission of the packet data from the early forward queue 130, in an embodiment.

The egress processor 106 is configured to receive packet data from the memory device 110 and to store the packet data in the cache memory 124, in an embodiment. The egress processor 106 is configured to, upon receiving a packet descriptor associated with a packet from the ingress processor 104, check whether the packet data corresponding the packet is currently stored in the cache memory 124. In response to determining that the packet data is currently stored in the cache memory 124, the egress processor 106 is configured to retrieve the packet data from the cache memory 124 for transmission of the packet via the network interface 112, without issuing a read request to the memory device 110. On the other hand, in response to determining that the packet data is not currently stored in the cache memory 124, the egress processor 106 is configured to issue a read request to the memory controller 126 of the memory device 110 to request the packet data from the memory device 110. The egress processor 106 is configured to continue checking the cache memory 124 for availability of the packet data in the cache memory 124, in an embodiment. When the packet data becomes available in the cache memory 124, the egress processor 106 retrieves the packet data from the cache memory 124 for transmission of the packet via the network interface 112, in an embodiment. In some embodiments, when packet data of a packet is split into multiple packet cells for storage in the memory device 110, the egress processor 106 is configured to wait until all packet cells are available in the cache memory 124 before retrieving the packet cells from the cache memory 124 for transmission of the packet via the network interface 112 in order to avoid underrun on the network interface 112.

In various embodiments, because the memory device 110 is configured to forward, to an egress processor 106, packet data directed to an uncongested network interface 112 coupled to the egress processor 106, without waiting for a read request for the packet data to be received from the egress processor 106, the packet data is available in the cache memory 124 of the egress processor 106 when the egress processor 106 is ready to transmit the packet, or soon after the egress processor 106 is ready to transmit the packet, in at least some scenarios, in an embodiment. Thus, latency associated with issuing a read request by the egress processor 106 to request the packet data from the memory device 110, and receiving the packet data by the egress processor 106 in response to the read request, is reduced or eliminated, in at least some scenarios, in an embodiment. Further, because the memory device 110 and the interface 116 are configured to prioritize packet data transmitted from the shared buffer 128, early forwarding of the packet data from the early forward queue 130 is performed without interfering with regular transmission of packet data from the shared buffer 128, in an embodiment. Additionally, because the memory device 110 is configured to store packet data in the early forward queue 130 in addition to storing the packet data in the shared buffer 128, the egress processor 106 is able to request and receive packet data via a read request and regular transmission of packet data from the shared buffer 128 in case the packet data transmitted from the early forward queue 130 does not reach the egress processor 106, or is delayed by transmission of packet data from the shared buffer 128, in an embodiment. Thus, storing the packet data in both the early forward queue 130 and the shared buffer 128 ensures that the packet data is not lost due to being dropped by the memory device 110 or the interface 116, in an embodiment. These and other techniques described herein allow the network device 100 to reduce or eliminate latency associated with the egress processor 106 issuing a read request to request the packet data from the memory device 110 for uncongested network interfaces 112 without interfering with the regular transmission of packet data from the shared buffer 128 and without requiring excessively large cache memory 124 for storing packet data directed to congested network interfaces 112 coupled to the egress processor 106, in various embodiments.

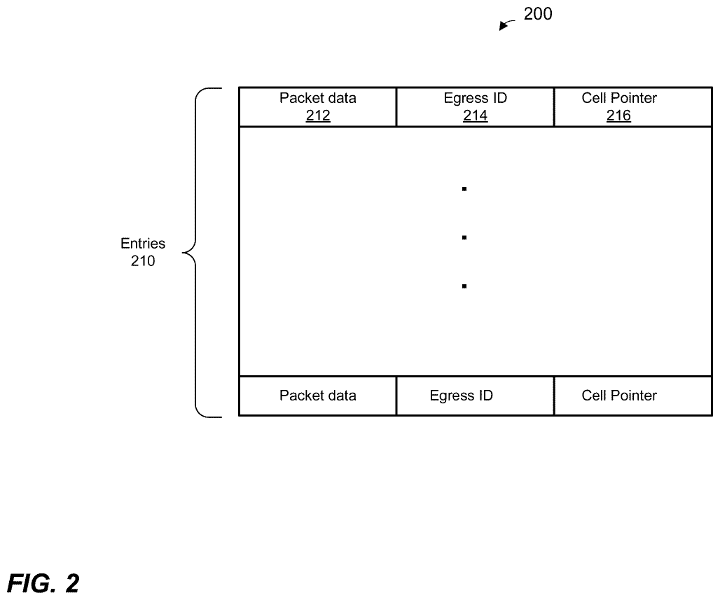

FIG. 2 is a diagram of an example early forward queue 200, according to an embodiment. In an embodiment, the early forward queue 200 corresponds to the early forward queue 130 of the network device 100 of FIG. 1, and the early forward queue 200 is described below with reference to FIG. 1 for ease of explanation. In other embodiments, the early forward queue 200 is used with network devices different from the network device 100 of FIG. 1. Similarly, the early forward queue 130 of the network device 100 of FIG. 1 is different from the early forward queue 200, in some embodiments.

The early forward queue 200 includes a plurality of entries 210, each entry 210 including a packet data field 212, an egress processor identifier field 214, and a cell pointer field 216, in an embodiment. The memory controller 126 is configured to store, in an entry 210 of the early forward queue 200, packet data received from an ingress processor 104, based on determining that the packet data is directed to an uncongested network interface 112, in an embodiment. The memory controller 126 is configured i) to store, in the packet data field 212, the packet cell received from the ingress processor 104, ii) to store, in the egress processor identifier field 214, the indicator of the egress processor 106 to which the packet cell is directed, and iii) to store, in the cell pointer field 216, the cell pointer indicating the memory location in which the packet cell is stored in the shared buffer 128, in an embodiment.

The early forward queue 200 is a FIFO queue, in an embodiment. Accordingly, the memory controller 126 is configured to store packet data (e.g., a packet cell) at a tail of the early forward queue 200 and to forward packet data from a head of the early forward queue 200, in an embodiment. The memory controller 126 is configured to give preference to transmission of packet data from the shared buffer 128, in an embodiment. Accordingly, the memory controller 126 is configured to forward the packet data from the early forward queue 200 when no data is to be transmitted from the shared buffer 128, in an embodiment.

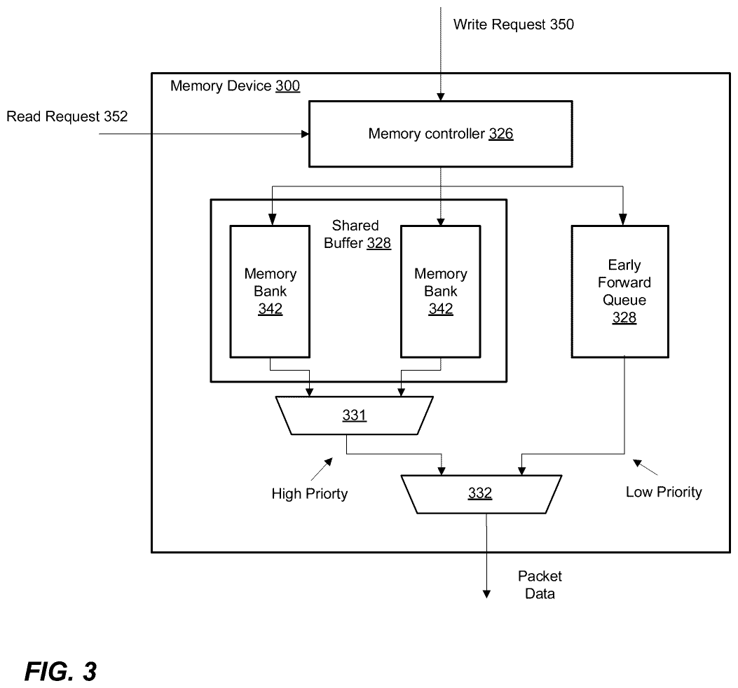

FIG. 3 is a block diagram of an example memory device 300, according to an embodiment. In an embodiment, the memory device 300 corresponds to the memory device 110 of the network device 100 of FIG. 1. In some embodiments, the memory device 110 of FIG. 1 includes multiple instances of the memory device 300. The memory device 300 is described below with reference to FIG. 1 for case of explanation. In other embodiments, the memory device 300 is used with network devices different from the network device 100 of FIG. 1. Similarly, the memory device 110 of the network device 100 of FIG. 1 is different from the memory device 300, in some embodiments.

The memory device 300 includes a memory controller 326, a shared buffer 328, and an early forward queue 330, in an embodiment. The memory controller 326 corresponds to the memory controller 126 of FIG. 1, the shared buffer 328 corresponds to the shared buffer 128 of FIG. 1, and the early forward queue 330 corresponds to the early forward queue 130 of FIG. 1, in an embodiment. The shared buffer 328 includes a plurality memory banks 342, in an embodiment. The memory device also includes a first multiplexer 331 and a second multiplexer 332 (corresponding to the multiplexer 132 od FIG. 1), in an embodiment. The memory controller 326 is configured to select outputs of the memory banks 342 of the shared buffer 328 by controlling the first multiplexer 331, in an embodiment. In another embodiment, the shared buffer 328 includes a single memory bank, and the first multiplexer 331 is omitted from the memory device 300.

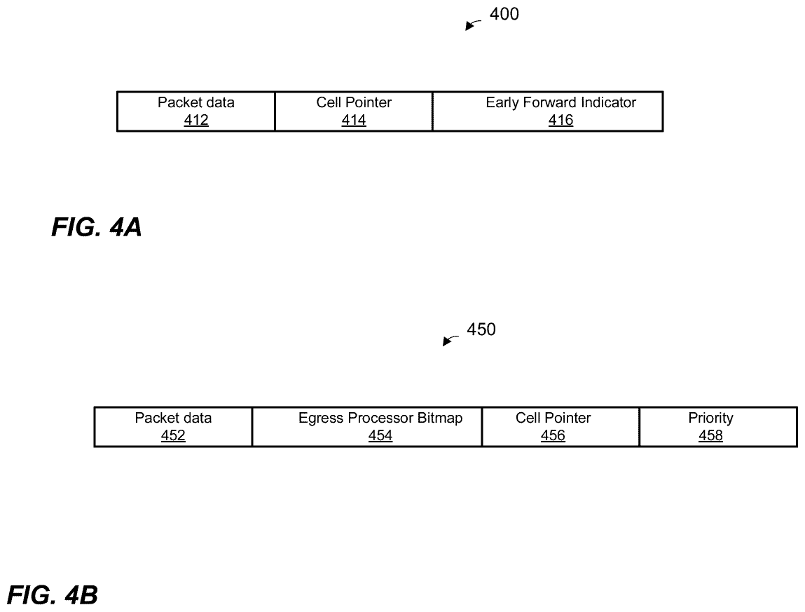

The memory controller 326 is configured to receive, from ingress processors 104, write requests 350 requesting to store, in the memory device 300, packet data corresponding to packets being processed by the ingress processors 104. FIG. 4A is a diagram of a write request 400 that corresponds to a write request 350 received by the memory device 300 from an ingress processor 104, in an embodiment. Referring to FIGS. 3 and 4A, the write request 400 includes a packet data field 412, a cell pointer field 414, and an early forward indicator field 416, in an embodiment. The packet data field 412 includes at least a portion of a packet (e.g., a payload of the packet) to be stored in the memory device 300, in an embodiment. The cell pointer field 414 is set to an indicator of a memory location in the shared buffer 328 allocated for storing the packet data in the packet data field 412, in an embodiment. In some embodiments, the write request 400 omits the cell pointer field 414. For example, the cell pointer field 414 is omitted from the write request 400 in an embodiment in which allocation of memory in the shared buffer 328 is performed by the memory device 300, in an embodiment. The early forward indicator field 416 set to indicate whether the packet data is to be forwarded to an egress processor 106 in an early forward operation without waiting for a read request from the egress processor 106, in an embodiment. In an embodiment, the ingress processor 104 is configured to set the early forward indicator field 416 to indicate that the packet data is to be transmitted to an egress processor 106 in an early forward operation based on determining (e.g., based on the congestion map 120) that the corresponding packet is directed to an uncongested network interface 112 coupled to the egress processor 106. In an embodiment, the ingress processor 104 is configured to set the early forward indicator field 416 to an identifier of the egress processor 106 to which the packet data is to be forwarded to indicate that the packet data is to be forwarded to the egress processor 106 in an early forward operation. For example, the early forward indicator field 416 set to a valid identifier of an egress processor 106 serves as an indication that the packet data is to be transmitted to the egress processor 106 without waiting for a read request for the packet data, in an embodiment. On the other hand, based on determining (e.g., based on the congestion map 120) that the corresponding packet is directed to a network interface 112 that is congested, the ingress processor 104 is configured to set the early forward indicator field 416 to a value other than a valid identifier of an egress processor 106, in an embodiment. In an embodiment, the ingress processor 104 is configured to set the early forward indicator field 416 to a value reserved for indicating that the packet data is not marked for early forward to an egress processor 106, in an embodiment.

With continued reference to FIGS. 3 and 4A, the memory controller 326 is configured to receive a write request 400 from an ingress processor 104, to allocate memory in one or more memory banks in the shared buffer 328 for storing the packet data from the packet data field 412, and to store the packet data in the memory allocated in the shared buffer 328. The memory controller 326 is configured to provide, to the ingress processor 104, one or more indicators of one or more memory locations at which the packet data from the packet data field 412 is stored in the shared buffer 328. The memory device 300 is further configured to determine, based on the early forward indicator field 416, whether the packet data is marked for early forward to an egress processor 106. The memory controller 326 is configured to, in response to determining that the packet data is marked for early forward to an egress processor 106, place the packet data from the packet data field 412 in an entry of the early forward queue 330 in addition to storing the packet data in the shared buffer 328, in an embodiment. In an embodiment, the memory controller 326 is configured to write, to the entry in the early forward queue 330, the packet data from the packet data field 412 and the indicator of the egress processor 106 from the early forward indicator field 416 of the write request 400. On the other hand, in response to determining that the packet data is not marked for early forward to an egress processor 106, the memory device 300 is configured to store the packet data from the packet data field 412 in the shared buffer 328 without also placing the packet data in the early forward queue 330, in an embodiment. The memory controller 326 is further configured to transmit packet data from the early forward queue 330 without waiting for read requests for the packet data to be received from egress processors 106, in an embodiment.

The memory controller 326 is also configured to receive, from the egress processors 106, read requests 352 requesting packet data from the memory device 300. A read request 352 received from an egress processor 106 includes the indicator of the memory location at which the packet data being requested is stored in the shared buffer 328. The read request 352 also includes an identifier of the egress processor 106 to which the packet data is to be transmitted, in an embodiment. The memory controller 326 is configured to, in response to receiving a read request 352 from an egress processor 106, retrieve the packet data from the memory location in the shared buffer 328 and transmit the packet data to the egress processor 106, in an embodiment. In an embodiment, the memory controller 326 is configured to transmit packet data from the shared buffer 328 and packet data from the early forward queue 330 via the shared interface 116 between the memory device 300 and the egress processors 106. Using a shared interface for transmission of packet data from the shared buffer 328 and the early forward queue 330 is beneficial in terms of area used by the interface, power consumption, etc., as compared to using separate interfaces, in various embodiments.

In an embodiment, the memory controller 326 is configured to handle transmissions from the shared buffer 328 with a higher priority relative to transmissions from the early forward queue 330. For example, the memory controller 326 is configured to control the multiplexer 332 to transmit packet data from the early forward queue 330 when no packet data is being transmitted from the shared buffer 328. The interface 116 is configured to handle transmissions from the shared buffer 328 with a higher priority relative to transmissions from the early forward queue 330. For example, the interface 116 is configured to transmit packet data transmitted from the early forward queue 330 when no packet data from the shared buffer 328 is being transmitted by the interface 116. The interface 116 is also configured to drop packet data transmitted from the early forward queue 330 to avoid queue overflow in the interface 116, in an embodiment. On the other hand, the interface 116 is configured to implement a backpressure technique with the memory device 300 to temporarily suspend transmission of packet data from the shared buffer 328 in order to avoid queue overflow in the interface 116 without the packet data being dropped in the interface 116, in an embodiment.

The memory controller 326 and the interface 116 are thus configured to transmit the packet data from the early forward queue 330 using bandwidth that is unused by transmissions from the shared buffer 328, in an embodiment. As a result, packet data from the shared buffer 328 is provided in a controlled and guaranteed manner to egress processors 106 in response to receiving read requests from the egress processors 106, whereas the packet data from the early forward queue 330 is transmitted as best effort, in an embodiment. As described in more detail below, if certain packet data that is transmitted to an egress processor 106 from the early forward queue 330 is not received by the egress processor 106 or receipt of the packet data is delayed, the egress processor 106 requests the packet data by transmitting a read request to the memory device 300 and receiving the packet data transmitted from the shared buffer 328 in a controlled and guaranteed manner in response to the read request, in an embodiment.

Referring briefly to FIG. 4B, the memory controller 326 is configured to generate a data unit 450 for transmission to an egress processor 106 via the interface 116, in an embodiment. The data unit 450 includes a packet data field 452, an egress processor indicator field 454, a cell pointer field 456, and a priority field 458. The packet data field 452 includes packet data retrieved from the shared buffer 328 or retrieved from the early forward queue 330. The egress processor indicator field 454 is set to indicate an egress processor 106 to which the data unit 450 is to be transmitted via the interface 116. For example, the egress processor indicator field 454 includes an egress processor bitmap in which a bit corresponding to an egress processor 106 to which the data unit 450 is to be transmitted is set to a first value (e.g., a logic one) and bits corresponding to other egress processors to which the data unit is not to be transmitted to a second value (e.g., a logic zero). In other embodiments, the egress processor indicator field 454 is set to indicate at least one processor to which the data unit 450 is to be transmitted in other suitable manners. The cell pointer field 456 includes the indicator of the memory location in the shared buffer 328 in which the corresponding packet data was stored, in an embodiment. The priority field 458 is set to indicate the priority of the data unit 450. In an embodiment, the priority field 458 is set to indicate high priority when the packet data in the packet data field 452 is packet data retrieved from the shared buffer 328. On the other hand, the priority field 458 is set to indicate low priority when the packet data in the packet data field 452 is packet data retrieved from the early forward queue 330, in an embodiment.

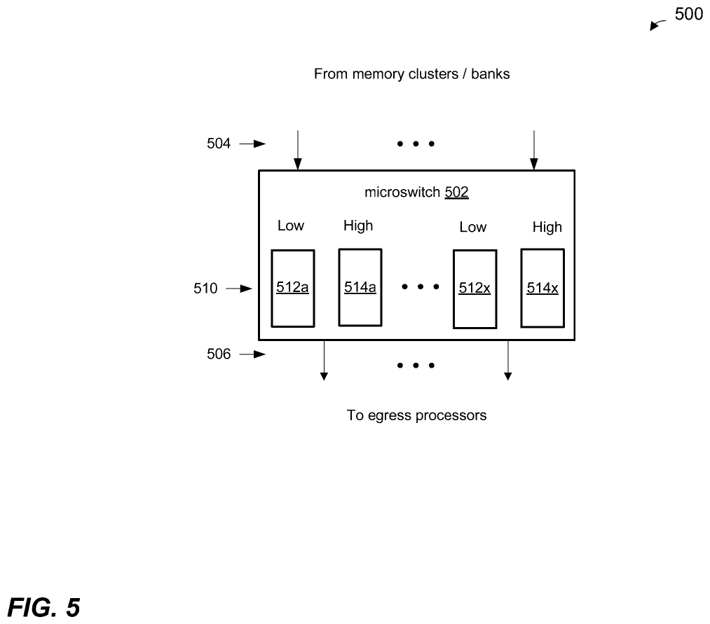

FIG. 5 is a block diagram of a shared interface 500 used for transmission of packet data from the shared buffer 328 and packet data retrieved from the early forward queue 330, in an embodiment. The shared interface 500 corresponds to the interface 116 of the network device 100 of FIG. 1, in an embodiment. The shared interface 500 is described below with reference to FIGS. 1 and 3 for case of explanation. However, the shared interface 500 is used with network devices different from the network device 100 of FIG. 1 and/or with memory devices different from the memory device 300 of FIG. 3, in some embodiments.

The shared interface 500 includes one or more microswitches 502, in an embodiment. Although a single microswitch 502 is illustrated in FIG. 5, the interface 500 includes multiple interconnected microswitches 502, in some embodiments. The microswitch 502 includes a plurality of inputs 504 interconnected with a plurality of outputs 506, in an embodiment. The inputs 504 are configured to receive data units, such as the data unit 450 of FIG. 4B, transmitted from respective memory clusters in the memory device 300, in an embodiment. The outputs 506 are configured to transmit data units, such as the data unit 450 of FIG. 4B, towards respective egress processors 106, in an embodiment. The microswitch 502 is configured to receive data units, such as the data unit 450 of FIG. 4B, transmitted from the memory device 300 and to forward the data units to appropriate outputs 506 for transmission of the data units towards egress processors 106 to which the data units are directed, in an embodiment. The microswitch 502 is configured to maintain respective sets of queues 510 corresponding to respective outputs 506, in an embodiment. Each set of queues 510 includes a low priority queue 512 and a high priority queue 514, in an embodiment. The microswitch 502 is configured to place a data unit 450 that includes packet data retrieved from the shared buffer 328, and is, therefore, marked as a high priority data unit in the priority field 458, in the high priority queue 514 corresponding to the output 506 via which the data unit 450 is to be forwarded towards the egress processor 106 indicated in the egress processor indicator field 454, in an embodiment. On the other hand, the microswitch 502 is configured to place a data unit 450 that includes packets data retrieved from the early forward queue 330, and is, therefore, marked as a low priority data unit in the priority field 458, in the low priority queue 512 corresponding to the output 506 via which the data unit 450 is to be forwarded towards the egress processor 106 indicated in the egress processor indicator field 454, in an embodiment.

In an embodiment, the microswitch 502 is configured to handle transmission of data units from the high priority queues 514 with higher priority relative to transmission of data units from the low priority queues 512. For example, the microswitch 502 is configured to transmit data units from a low priority queue 512 only when there is no data units in the corresponding high priority queue 514. In other embodiments, the microswitch 502 is configured to implement a different transmission scheme that gives preference to transmission of data units from a high priority queue 514 relative to transmission of data units from a corresponding low priority queue 512. In an embodiment, the microswitch is configured to drop data units directed to low priority queues 512 in order to avoid overflow of the low priority queues 512. As an example, the microswitch 502 is configured to drop one in a certain number (e.g., 2, 3, 4, etc.) data units directed to a low priority queue 512 when a fill level of the low priority queue 512 is higher than a certain threshold. In other embodiments, the microswitch 502 is configured to implement other suitable drop schemes (e.g., other suitable drop probabilities or thresholds) to avoid overflow of the low priority queues 512. On the other hand, microswitch 502 is configured to implement a backpressure scheme with the memory device 300 at times of congestion in the microswitch 502, in order to avoid overflow in high priority queues 514, in an embodiment. For example, the microswitch 502 is configured to send a backpressure signal to the memory device 300 when a fill level of a high priority queue 514 exceeds a certain threshold, for example due to congestion in a path towards the corresponding egress processor 106, in an embodiment. The memory device 300 is configured to, in response to receiving the backpressure signal from the microswitch 502, temporarily suspend transmission of data units directed to the egress processor 106, thereby avoiding overflow of the high priority queue 514 without dropping the data units in the interface 500, in an embodiment.

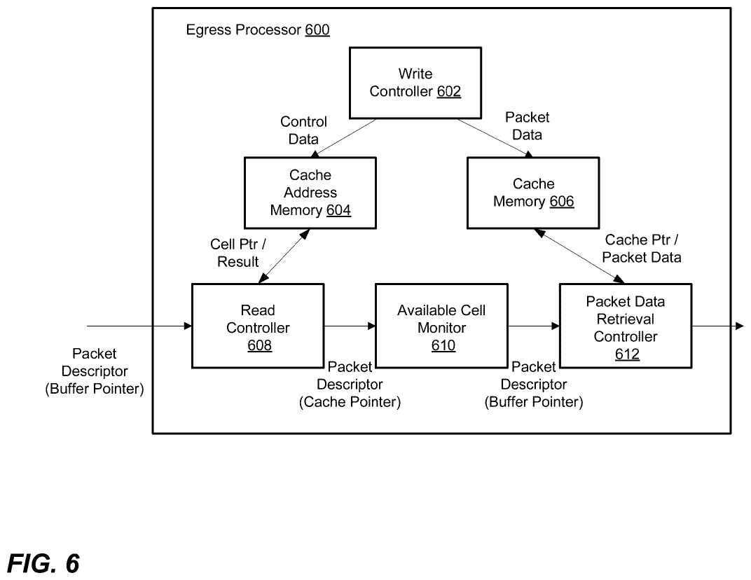

FIG. 6 is a diagram of an example egress processor 600, according to an embodiment. In an embodiment, the egress processor 600 corresponds to each of the one or more egress processors 106 of the network device 100 of FIG. 1, and the egress processor 600 is described below with reference to FIG. 1 for ease of explanation. In other embodiments, the egress processor 600 is used with network devices different from the network device 100 of FIG. 1. Similarly, the one or more egress processors 106 of the network device 100 of FIG. 1 are different from the egress processor 600, in some embodiments.

The egress processor 600 includes a write controller 602, a cache address memory 604, a cache memory 606, a read controller 608, a cell monitor 610, and a packet data retrieval controller 612, in an embodiment. In some embodiments, the egress processor 600 omits one or more of the components illustrated in FIG. 6 and/or includes one or more additional components not illustrated in FIG. 6. For example, the egress processor 600 omits the cell monitor 610, in some embodiments.

The write controller 602 is configured to receive data units transmitted from the memory device 300 and to write packet data included in the data units in the cache memory 606. The write controller 602 is also configured to write cell pointers obtained from the data units in the cache address memory 604. In an embodiment, the cell pointers in the cache address memory 604 indicate that corresponding packet data is stored in the cache memory 606 and, further, indicates a memory location at which the corresponding packet data is stored in the cache memory 606. The read controller 608 is configured to receive packet descriptors from the ingress processors 104. The read controller 608 is configured to obtain a cell pointer from a packet descriptor received from an ingress processor 104, where the cell pointer indicates the memory location that was allocated for storing packet data of the corresponding packet in the shared buffer 328 of the memory device 300. The read controller 608 is configured to search the cache address memory 604 using the cell pointer obtained from the packet descriptor to determine whether the packet data of the corresponding packet is currently stored in the cache memory 606. In response to determining that the packet data is currently stored in the cache memory 606, the read controller 608 is configured to provide the packet descriptor along with an indicator of the memory location at which the packet cell is stored in the cache memory 606, to the cell monitor 610. On the other hand, in response to determining that the packet data is not currently stored in the cache memory 606, the read controller is configured to issue a read request to the memory device 300 to request the packet data from the memory device 300.

The cell monitor 610 is configured to determine when all packet cells corresponding to a packet are available in the cache memory 606, in an embodiment. For example, when a packet cell is not initially available in the cache memory 606, the cell monitor is configured to snoop, or periodically search, the cache address memory 604 based on the cell pointer corresponding to the packet cell to determine when the packet cell becomes available in the cache memory 606. The packet cell becomes available in the cache memory 606 when a data unit 450 that includes the packet cell is received by the write controller 602, and the packet data from the data unit 450 is written to the cache memory 606 by the write controller 602. The data unit 450 that includes the packet cell is received by the write controller 602 i) in response to the read request issued by the read controller 608, in which case the packet data is transmitted to the egress processor 600 from the shared buffer 328 of the memory device 300 or ii) when the data unit 450 that includes the packet data transmitted to the egress processor 600 from the early forward queue 330 of the memory device 300 reaches the egress processor 600 before the response to the read request issued by the read controller 608, for example.

In an embodiment, when the cell becomes available in the cache memory 606, the cell monitor 610 forwards the packet descriptor, along with the indicator of the memory location at which the packet cell is stored in the cache memory 606, to the packet data retrieval controller 612. The packet data retrieval controller 612 is configured to retrieve the packet cell from the cache memory 606 for transmission of the packet via the network interface 112, in an embodiment. In some embodiments in which the at least the portion of a packet (e.g., at least the payload of the packet) is split into multiple cells for storage in the memory device 300, the cell monitor 610 is configured to wait until all of the packet cells are available in cache memory 606 and to forward the packet descriptor (or respective packet descriptors corresponding to respective ones of the packet cells), along with the indicators of the memory locations at which the packet cells are stored in the cache memory 606, to the packet data retrieval controller 612. The packet data retrieval controller 612 is configured to retrieve the multiple packet cells from the cache memory 606 for transmission of the packet via the network interface 112, in an embodiment. Waiting until all packet cells of a packet are available in the cache memory 606 before retrieving the packet cells from the cache memory 606 and providing the packet data from transmission via the network interface 112 ensures that there is no underrun of the network interface 112, in an embodiment. In an embodiment, the cell monitor 610 is configured to wait until all cells of a packet are available in the cache memory 606 only for packet data that is transmitted to the egress processor 600 from the early forward queue 330 of the memory device 300. For packet data that is transmitted from the early forward queue 330 of the memory device 300 there is no guarantee that a next cell of a packet will be available in, and retrieved from, the cache memory 606 when transmission a previous cell of the packet is completed by the network interface 112, in an embodiment. On the other hand, for packet data that is transmitted to the egress processor 600 from the shared buffer 228 of the memory device 300, a maximum latency of transmission the packet data from the memory device 300 to the egress processor 600 is guaranteed, in an embodiment. Accordingly, for packet data that is transmitted to the egress processor 600 from the shared buffer 228 of the memory device 300, the cell monitor 610 is configured to provide a packet descriptor, along with an indicator of the memory location at which a packet cell is stored in the cache memory 606, to the packet data retrieval controller 612 without waiting until all cells of the packet are available in the cache memory 606, in at least some situations, without causing underrun of the network interface 112 via which the packet is being transmitted, in an embodiment.

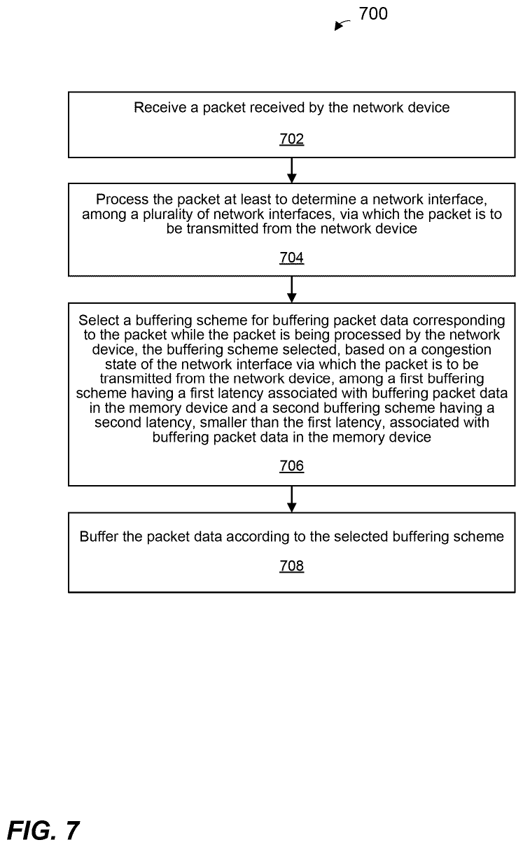

FIG. 7 is a flow diagram of an example method 700 for processing packets in a network device, according to an embodiment. The method 700 is implemented by the network device 100 of FIG. 1, according to an embodiment. The method 700 is described with reference to FIG. 1 merely for illustrative purposes. In other embodiments, the method 700 is implemented by another suitable network device different than the network device 100 of FIG. 1.

At a block 702, a packet is received via a first network interface among a plurality of network interfaces of the network device. For example, the packet is receiving via a first network interface 112 among the plurality of network interfaces 112 of the network device 100. In an embodiment, the packet is received by an ingress processor 104 coupled to the first network interface 112 of the network device 100.

At a block 704, the packet is processed by the network device. For example, the packet is processed by the ingress processor 104 of the network device 100. Processing of the packet at the block 704 includes determining a second network interface 112, among the plurality of network interfaces 112 of the network device 100, via which the packet is to be transmitted from the network device. For example, the packet is processed by the forwarding engine 118 to determine the second network interface 112 via which the packet is to be transmitted from the network device 100.

At a block 706, a buffering scheme is selected for buffering packet data corresponding to the packet in a memory device (e.g., the memory device 110 of FIG. 1) while the packet is being processed by the network device. In an embodiment, the buffering scheme is selected at block 706 based on a congestion state of the network interface via which the packet is to be transmitted by the network device. The buffering scheme is selected at block 706 among a first buffering scheme having a first latency associated with buffering packet data in the memory device and a second buffering scheme having a second latency, smaller than the first latency, associated with buffering packet data in the memory device, in an embodiment. In an embodiment, the first buffering scheme is selected at block 706 when the network interface via which the packet is to be transmitted by the network device is congested. On the other hand, the second buffering scheme is selected at block 706 when the network interface via which the packet is to be transmitted by the network device is not congested.

At a block 708, the packet data is buffered in the memory device according to the first buffering scheme or the second buffering scheme selected for buffering the packet data at block 706. In an embodiment, buffering the packet data according to the first buffering scheme includes i) storing the packet data in a buffer (e.g., the shared buffer 128 of the memory device 110) and ii) retrieving the packet data from the buffer of the memory device (e.g., the shared buffer 128 of the memory device 110) in response to receiving a read request from an egress processor (e.g., egress processor 106) to which the packet data is directed, and iii) providing the packet retrieved from the buffer of the memory device (e.g., the shared buffer 128 of the memory device 110) to the egress processor. On the other hand, buffering the packet data according to the second buffering scheme includes placing the packet data in an early forward queue of the memory device (e.g., the early forward queue 130 of the memory device 110) for transmission of the packet data to the egress processor to which the packet data is directed without receiving a read request from the egress processor. Buffering the packet data according to the second buffering scheme also includes further storing the packet data in the buffer of the memory device (e.g., the shared buffer 128 of the memory device 119) in addition to placing the packet data in the early forward queue of the memory device (e.g., the early forward queue 130 of the memory device 110), in an embodiment.

In an embodiment, the method 700 further includes providing the packet data from the memory device to an egress processor coupled to the second network interface, and transmitting the packet, including the packet data, via the second network interface. In an embodiment, the method 700 includes transmitting packet data from either i) the buffer of the memory device or ii) the early forward queue of the memory device to the egress processor via a shared interface between the memory device and the egress processor. In some embodiments, providing the packet data from the memory device to the egress processor includes transmitting the packet data from the buffer of the memory device via the shared interface with a higher priority relative to transmission of packet data from the early forward queue of the memory device via the shared interface.

The method 700 further includes receiving, by the egress processor, the packet data from the memory device, in an embodiment and storing the packet data in a cache memory of the egress processor, in an embodiment. The method 700 also includes receiving, by the egress processor, a packet descriptor associated with the packet from the ingress processor, the packet descriptor including an indication of a memory location that was allocated by the memory device for storing the packet data, in an embodiment. The method 700 further includes, in response to receiving the packet descriptor, determining, by the egress processor based on the indication of a memory location that was allocated by the memory device for storing the packet data, whether the packet data is currently stored in the cache memory, in an embodiment. The method 700 also includes, in response to determining that the packet data is currently stored in the cache memory, retrieving, by the egress processor, the packet data from the cache memory for transmission of the packet via the second network interface, in an embodiment. The method 700 additionally includes, in response to determining, by the egress processor, that the packet is not currently stored in the cache memory, i) transmitting, by the egress processor to the memory device, a read request to obtain the packet data from the memory device, ii) monitoring, by the egress processor, the cache memory to determine when the packet data becomes available in the cache memory, and iii) in response to determining that the packet is available in the cache memory, retrieving, by the egress processor, the packet data from the cache memory for transmission of the packet via the second network interface of the network device.

In various embodiments, because the method 700 includes forwarding, to an egress processor, packet data directed to an uncongested network interface 112 coupled to the egress processor, without waiting for a read request for the packet data to be received from the egress processor, the packet data is available in a cache memory of the egress processor when the egress processor is ready to transmit the packet, or soon after the egress processor is ready to transmit the packet, in at least some scenarios, in an embodiment. Thus, latency associated with issuing a read request by the egress processor to request the packet data from the memory device, and receiving the packet data by the egress processor in response to the read request, is reduced or eliminated, in at least some scenarios, in an embodiment. Further, because the memory device and the interface between the memory device and the egress processor are configured to prioritize packet data transmitted from a buffer of the memory device, early forwarding of the packet data from an early forward queue of the memory device is performed without interfering with regular transmission of packet data from the buffer, in an embodiment. Additionally, because the method 700 includes storing packet data in the early forward queue of the memory device in addition to storing the packet data in the buffer of the memory device, the egress processor is able to request and receives packet data via regular transmission of packet data from the buffer in case the packet data transmitted from the early forward queue does not reach the egress processor, or is delayed by transmission of packet data from the shared buffer 128, in an embodiment. Thus, storing the packet data in both the early forward queue and the buffer of the memory device ensures that the packet data is not lost due to being dropped by the memory device or the interface between the memory device and the egress processor, in an embodiment. Thus, latency associated with the egress processor issuing a read request to request the packet data from the memory device for uncongested network interfaces is reduced or eliminated without interfering with the regular transmission of packet data from the buffer and without requiring an excessively large cache memory for storing packet data directed to congested network interfaces coupled to the egress processor, in various embodiments.

Embodiment 1: A network device, comprising: a plurality of network interfaces; an ingress processor configured to process packets received by the network device to determine network interfaces, among the plurality of network interfaces, via which the packets are to be transmitted by the network device; a memory device configured to buffer packet data corresponding to the packets while the packets are being processed by the network device; and a memory controller configured to select a buffering scheme for buffering a packet in the memory device based on a congestion state of a network interface via which the packet is to be transmitted by the network device, the buffering scheme being selected among a first buffering scheme having a first latency associated with buffering packet data in the memory device and a second buffering scheme having a second latency, smaller than the first latency, associated with buffering packet data in the memory device.

Embodiment 2: The network device of embodiment 1, wherein the memory controller is configured to: select the first buffering scheme, having the first latency, for buffering the packet when the network interface via which the packet is to be transmitted by the network device is congested; and select the second buffering scheme, having the second latency smaller than the first latency, when the network interface via which the packet is to be transmitted by the network device is not congested.

Embodiment 3: The network device of embodiment 1 or 2, wherein the ingress processor is configured to: maintain a congestion map including indications of whether respective network interfaces among the plurality of network interfaces are congested; determine, based on the congestion map, whether the network interface via which the packet is to be transmitted is congested; and provide, to the memory controller, a congestion indication indicating whether the network interface is congested, wherein the memory controller is configured to select the buffering scheme for buffering the packet based on the congestion indication received from the ingress processor.

Embodiment 4: The network device of embodiment 3, wherein the ingress processor is further configured to, in response to determining that the network interface via which the packet is to be transmitted is not congested, further provide to the memory controller an identifier of an egress processor to which the packet data is to be forwarded by the memory device.

Embodiment 5: The network device of any of embodiments 1-4, wherein the memory controller is configured to: in response to selecting the first buffering scheme, i) store the packet data in a buffer of the memory device, ii) retrieve the packet data from the buffer in response to receiving a read request from an egress processor and iii) provide the packet retrieved from the memory device to the egress processor; and in response to selecting the second buffering scheme, i) place the packet data in an early forward queue and ii) transmit the packet data from the early forward queue to an egress processor, coupled to the network interface via which the packet is to be transmitted from the network device, without receiving a read request from the egress processor.

Embodiment 6: The network device of embodiment 5, wherein the memory controller is further configured to, in response to selecting the second buffering scheme, further store the packet data in the buffer of the memory device in addition to placing the packet data in the early forward queue of the memory device.

Embodiment 7: The network device of embodiment 5, wherein the memory controller is configured to cause the packet data to be transmitted from the memory device to an egress processor from either i) the buffer of the memory device or ii) the early forward queue of the memory device via a shared interface between the memory device and the egress processor.

Embodiment 8: The network device of embodiment 7, wherein the memory controller is configured to handle transmission of packet data from the buffer of the memory device via the shared interface with a higher priority relative to transmission of packet data from the early forward queue of the memory device via the shared interface.

Embodiment 9: The network device of embodiment 7, wherein the egress processor is configured to: store packet data received from the memory device in a cache memory of the egress processor; receive a packet descriptor associated with the packet from an ingress processor, the packet descriptor including an indication of a memory location that was allocated for storing the packet data in the memory device; in response to receiving the packet descriptor, determine based on the indication of a memory location that was allocated by the memory device for storing the packet data, whether the packet data is currently stored in the cache memory; and in response to determining that the packet data is currently stored in the cache memory, retrieve the packet data from the cache memory for transmission of the packet via the network interface of the network device.

Embodiment 10: The network device of embodiment 9, wherein the egress processor is further configured to: in response to determining that the packet is not currently stored in the cache memory, transmit, to the memory device, a read request to obtain the packet data from the memory device; monitor the cache memory to determine when the packet data becomes available in the cache memory; and in response to determining that the packet is available in the cache memory, retrieve the packet data from the cache memory for transmission of the packet via second network interface of the network device.

Embodiment 11: The network device of any of embodiments 7-10, wherein: the egress processor is one of a plurality of egress processors of the network device, wherein respective ones of the plurality of egress processors are coupled to respective subsets of network interfaces among the plurality of network interfaces; and the memory device includes a shared buffer configured to store packet data directed to the plurality of egress processors.

Embodiment 12: A method for processing packets in a network device, the method including: receiving, by an ingress processor of the network device, a packet received by the network device; processing, by the ingress processor of the network device, the packet at least to determine a network interface, among a plurality of network interfaces of the network device, via which the packet is to be transmitted from the network device; selecting a buffering scheme for buffering the packet in a memory device while the packet is being processed by the network device, the buffering scheme being selected, based on a congestion state of the network interface via which the packet is to be transmitted from the network device, among a first buffering scheme having a first latency associated with buffering packet data in the memory device and a second buffering scheme having a second latency, smaller than the first latency, associated with buffering packet data in the memory device; and buffering the packet according to the selected buffering scheme in the memory device.

Embodiment 13: The method of embodiment 12, wherein selecting the buffering scheme includes: selecting the first buffering scheme, having the first latency, for buffering the packet when the network interface via which the packet is to be transmitted by the network device is congested; and selecting the second buffering scheme, having the second latency smaller than the first latency, when the network interface via which the packet is to be transmitted by the network device is not congested.

Embodiment 14: The method of embodiment 12 or 13, further comprising: providing the packet data from the memory device to an egress processor coupled to the network interface via which the packet is to be transmitted by the network device; and transmitting the packet, including the packet data, via the network interface.

Embodiment 15: The method of any of embodiments 12-14, further comprising: maintaining, by the ingress processor, a congestion map including indications of whether respective network interfaces among the plurality of network interfaces are congested; determining, by the ingress processor based on the congestion map, whether the network interface via which the packet is to be transmitted is congested; and providing, to the memory device, a congestion indication indicating whether the network interface is congested, wherein selecting the buffering scheme for buffering the packet data in the memory device includes selecting the buffering scheme based on the congestion indication.

Embodiment 16: The method of embodiment 14 or 15, wherein buffering the packet data in the memory device includes: based on selecting the first buffering scheme i) storing the packet data in a buffer of the memory device, ii) retrieving the packet data from the buffer of the memory device in response to receiving a read request from the egress processor and iii) providing the packet data retrieved from buffer of the memory device to the egress processor; and based on selecting the second buffering scheme, placing the packet data in an early forward queue of the memory device for transmission of the packet data to the egress processor without receiving a read request from the egress processor.

Embodiment 17: The method of embodiment 16, wherein buffering the packet data in the memory device includes, based on selecting the second buffering scheme, further storing the packet data in the buffer of the memory device in addition to placing the packet data in the early forward queue of the memory device.

Embodiment 18: The method of embodiment 16, wherein providing the packet data from the memory device to the egress processor includes transmitting packet data from either i) the buffer of the memory device or ii) the early forward queue of the memory device to the egress processor via a shared interface between the memory device and the egress processor.

Embodiment 19: The method of claim 17, wherein providing the packet data from the memory device to the egress processor includes transmitting of packet data from the buffer of the memory device via a shared interface with a higher priority relative to transmission of packet data from the early forward queue of the memory device via the shared interface.

Embodiment 20: The method of any of embodiments 14-19, further comprising: receiving, by the egress processor, the packet data from the memory device; storing the packet data in a cache memory of the egress processor; receiving, by the egress processor, a packet descriptor associated with the packet from the ingress processor, the packet descriptor including an indication of a memory location that was allocated by the memory device for storing the packet data; in response to receiving the packet descriptor, determining, by the egress processor based on the indication of a memory location that was allocated by the memory device for storing the packet data, whether the packet data is currently stored in the cache memory; in response to determining that the packet is currently stored in the cache memory, retrieving, by the egress processor, the packet data from the cache memory for transmission of the packet via the network interface of the network device; and .in response to determining, by the egress processor, that the packet is not currently stored in the cache memory, transmitting, by the egress processor to the memory device, a read request to obtain the packet data from the memory device, monitoring, by the egress processor, the cache memory to determine when the packet data becomes available in the cache memory, and in response to determining that the packet data is available in the cache memory, retrieving, by the egress processor, the packet data from the cache memory for transmission of the packet via the network interface of the network device.

At least some of the various blocks, operations, and techniques described above are suitably implemented utilizing dedicated hardware, such as one or more of discrete components, an integrated circuit, an application-specific integrated circuit (ASIC), a programmable logic device (PLD), a processor executing firmware instructions, a processor executing software instructions, or any combination thereof. When implemented utilizing a processor executing software or firmware instructions, the software or firmware instructions may be stored in any suitable computer readable memory such a read-only memory (ROM), a random-access memory (RAM), etc. The software or firmware instructions may include machine readable instructions that, when executed by one or more processors, cause the one or more processors to perform various acts.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A network device, comprising:
a plurality of network interfaces;
an ingress processor configured to process packets received by the network device to determine network interfaces, among the plurality of network interfaces, via which the packets are to be transmitted by the network device;
a memory device configured to buffer packet data corresponding to the packets while the packets are being processed by the network device; and
a memory controller configured to select a buffering scheme for buffering a packet in the memory device based on a congestion state of a network interface via which the packet is to be transmitted by the network device, the buffering scheme being selected among a first buffering scheme having a first latency associated with buffering packet data in the memory device and a second buffering scheme having a second latency, smaller than the first latency, associated with buffering packet data in the memory device.

2. The network device of claim 1, wherein the memory controller is configured to:
select the first buffering scheme, having the first latency, for buffering the packet when the network interface via which the packet is to be transmitted by the network device is congested; and
select the second buffering scheme, having the second latency smaller than the first latency, when the network interface via which the packet is to be transmitted by the network device is not congested.

3. The network device of claim 1, wherein the ingress processor is configured to:
maintain a congestion map including indications of whether respective network interfaces among the plurality of network interfaces are congested;
determine, based on the congestion map, whether the network interface via which the packet is to be transmitted is congested; and
provide, to the memory controller, a congestion indication indicating whether the network interface is congested, wherein the memory controller is configured to select the buffering scheme for buffering the packet based on the congestion indication received from the ingress processor.

4. The network device of claim 3, wherein the ingress processor is further configured to, in response to determining that the network interface via which the packet is to be transmitted is not congested, further provide to the memory controller an identifier of an egress processor to which the packet data is to be forwarded by the memory device.

5. The network device of claim 1, wherein the memory controller is configured to:
in response to selecting the first buffering scheme, i) store the packet data in a buffer of the memory device, ii) retrieve the packet data from the buffer in response to receiving a read request from an egress processor and iii) provide the packet retrieved from the memory device to the egress processor; and
in response to selecting the second buffering scheme, i) place the packet data in an early forward queue and ii) transmit the packet data from the early forward queue to an egress processor, coupled to the network interface via which the packet is to be transmitted from the network device, without receiving a read request from the egress processor.

6. The network device of claim 5, wherein the memory controller is further configured to, in response to selecting the second buffering scheme, further store the packet data in the buffer of the memory device in addition to placing the packet data in the early forward queue of the memory device.

7. The network device of claim 5, wherein the memory controller is configured to cause the packet data to be transmitted from the memory device to an egress processor from either i) the buffer of the memory device or ii) the early forward queue of the memory device via a shared interface between the memory device and the egress processor.

8. The network device of claim 7, wherein the memory controller is configured to handle transmission of packet data from the buffer of the memory device via the shared interface with a higher priority relative to transmission of packet data from the early forward queue of the memory device via the shared interface.

9. The network device of claim 7, wherein the egress processor is configured to:
store packet data received from the memory device in a cache memory of the egress processor;
receive a packet descriptor associated with the packet from an ingress processor, the packet descriptor including an indication of a memory location that was allocated for storing the packet data in the memory device;
in response to receiving the packet descriptor, determine based on the indication of a memory location that was allocated by the memory device for storing the packet data, whether the packet data is currently stored in the cache memory; and
in response to determining that the packet data is currently stored in the cache memory, retrieve the packet data from the cache memory for transmission of the packet via the network interface of the network device.

10. The network device of claim 9, wherein the egress processor is further configured to:
in response to determining that the packet is not currently stored in the cache memory,
transmit, to the memory device, a read request to obtain the packet data from the memory device,
monitor the cache memory to determine when the packet data becomes available in the cache memory, and
in response to determining that the packet is available in the cache memory, retrieve the packet data from the cache memory for transmission of the packet via second network interface of the network device.

11. The network device of claim 7, wherein:
the egress processor is one of a plurality of egress processors of the network device, wherein respective ones of the plurality of egress processors are coupled to respective subsets of network interfaces among the plurality of network interfaces; and
the memory device includes a shared buffer configured to store packet data directed to the plurality of egress processors.

12. A method for processing packets in a network device, the method comprising:
receiving, by an ingress processor of the network device, a packet received by the network device;
processing, by the ingress processor of the network device, the packet at least to determine a network interface, among a plurality of network interfaces of the network device, via which the packet is to be transmitted from the network device;
selecting a buffering scheme for buffering the packet in a memory device while the packet is being processed by the network device, the buffering scheme being selected, based on a congestion state of the network interface via which the packet is to be transmitted from the network device, among a first buffering scheme having a first latency associated with buffering packet data in the memory device and a second buffering scheme having a second latency, smaller than the first latency, associated with buffering packet data in the memory device; and
buffering the packet according to the selected buffering scheme in the memory device.

13. The method of claim 12, wherein selecting the buffering scheme includes:
selecting the first buffering scheme, having the first latency, for buffering the packet when the network interface via which the packet is to be transmitted by the network device is congested; and
selecting the second buffering scheme, having the second latency smaller than the first latency, when the network interface via which the packet is to be transmitted by the network device is not congested.

14. The method of claim 12, further comprising:
providing the packet data from the memory device to an egress processor coupled to the network interface via which the packet is to be transmitted by the network device; and
transmitting the packet, including the packet data, via the network interface.

15. The method of claim 12, further comprising:
maintaining, by the ingress processor, a congestion map including indications of whether respective network interfaces among the plurality of network interfaces are congested;
determining, by the ingress processor based on the congestion map, whether the network interface via which the packet is to be transmitted is congested; and
providing, to the memory device, a congestion indication indicating whether the network interface is congested, wherein selecting the buffering scheme for buffering the packet data in the memory device includes selecting the buffering scheme based on the congestion indication.

16. The method of claim 14, wherein buffering the packet data in the memory device includes:
based on selecting the first buffering scheme i) storing the packet data in a buffer of the memory device, ii) retrieving the packet data from the buffer of the memory device in response to receiving a read request from the egress processor and iii) providing the packet data retrieved from buffer of the memory device to the egress processor; and
based on selecting the second buffering scheme, placing the packet data in an early forward queue of the memory device for transmission of the packet data to the egress processor without receiving a read request from the egress processor.

17. The method of claim 16, wherein buffering the packet data in the memory device includes, based on selecting the second buffering scheme, further storing the packet data in the buffer of the memory device in addition to placing the packet data in the early forward queue of the memory device.

18. The method of claim 16, wherein providing the packet data from the memory device to the egress processor includes transmitting packet data from either i) the buffer of the memory device or ii) the early forward queue of the memory device to the egress processor via a shared interface between the memory device and the egress processor.

19. The method of claim 17, wherein providing the packet data from the memory device to the egress processor includes transmitting of packet data from the buffer of the memory device via a shared interface with a higher priority relative to transmission of packet data from the early forward queue of the memory device via the shared interface.

20. The method of claim 14, further comprising:
receiving, by the egress processor, the packet data from the memory device;
storing the packet data in a cache memory of the egress processor;
receiving, by the egress processor, a packet descriptor associated with the packet from the ingress processor, the packet descriptor including an indication of a memory location that was allocated by the memory device for storing the packet data;
in response to receiving the packet descriptor, determining, by the egress processor based on the indication of a memory location that was allocated by the memory device for storing the packet data, whether the packet data is currently stored in the cache memory;
in response to determining that the packet is currently stored in the cache memory, retrieving, by the egress processor, the packet data from the cache memory for transmission of the packet via the network interface of the network device; and
in response to determining, by the egress processor, that the packet is not currently stored in the cache memory,
transmitting, by the egress processor to the memory device, a read request to obtain the packet data from the memory device,
monitoring, by the egress processor, the cache memory to determine when the packet data becomes available in the cache memory, and
in response to determining that the packet data is available in the cache memory, retrieving, by the egress processor, the packet data from the cache memory for transmission of the packet via the network interface of the network device.
